(19) United States
(12) Patent Application Publication
(10) Pub. No.: US 2006/0141295 A1
(43) Pub. Date: Jun. 29, 2006

(54) Reactor and fuel cell system therewith

(75) Inventors: Yuusuke Sato, Bunkyo-ku (JP); Fuminobu Tezuka, Yokohama-shi (JP); Masahiro Kuwata, Kawasaki-shi (JP); Hideo Kitamura, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 11/234,231

(22) Filed: Sep. 26, 2005

(30) Foreign Application Priority Data
Dec. 28, 2004 (JP) 2004-378818

(51) Int. Cl. B01J 19/00; H01M 8/00

(52) U.S. Cl. 429/12; 422/129

(57) ABSTRACT

A fuel cell system is provided with a reactor. The reactor is provided with a first member including plural first projections; a second member including plural second projections, the second projections being so dimensioned as to at least partly enter into gaps between the respective first projections; a catalyst supported on at least apart of surfaces of the first projections and the second projections; and a case to house the first member and the second member, the case including an inflow port and an outflow port.

### CROSS-REFERENCE TO RELATED APPLICATIONS

This application is based upon and claims the benefit of priority from the prior Japanese Patent Application No. 2004-378818 (filed Dec. 28, 2004); the entire contents of which are incorporated herein by reference.

### BACKGROUND OF THE INVENTION

1. Field of the Invention

The present invention relates to a reactor in which catalysts for promoting chemical reactions are supported and a fuel cell system using hydrogen extracted from a fuel by a reforming reaction in the reactor to generate electricity.

2. Description of the Related Art

Compact reactors having reactor therein are now under active development. Such compact reactors can be preferably applied to various compact devices such as a cellular phone and, as well, have another advantages. The following advantages are recited in Japanese Patent Application Laid-open No. 2003-88754 in a paragraph [0006].

(1) The reaction volume in the reactor is made smaller, thereby the effect of the ratio of the surface area to the volume becomes prominent. This leads to an advantage that a property of thermal conduction at a time of catalytic reaction is improved and reaction efficiency is improved.

(2) Time of diffusion and mixing of the reaction molecules composing the mixed substances is made shorter. This leads to another advantage that rate of progress (rate of reaction) of catalytic reaction in the reaction flow path is improved.

(3) The other advantage is that a plurality of structures each including the reaction flow path are layered with each other so that any complicated study in view of the reaction engineering with respect to scale-up (enlargement of the scale of the device or increase in production capacity of fluid substances) is unnecessary.

A usual reactor is, as described in the above citation, comprised of a small substrate of silicon or such and a sealing substrate of glass or such. The small substrate, as described in a paragraph [0031] of the citation, has grooves on one surface thereof, which are etched into arbitrary groove shapes by a photo-etching technique and such. A catalyst of a copper-zinc family is formed and adhered on inner surfaces of the grooves by a CVD method and such. The sealing substrate is joined to the small substrate, as opposing to the surface having the grooves. Thereby the flow path having the catalyst therein is formed.

Japanese Patent Applications Laid-open No. H06-260189 and H02-4448 disclose arts related to the reactor.

Such usual reactors are adapted to laboratory uses, however, not adapted to mass production for general uses. The reason is that high aspect ratio (a ratio of depth to width) required for such grooves cannot be achieved in high productivity by the usual photo-etching technique or machining techniques.

### SUMMARY OF THE INVENTION

The present invention is intended for providing a reactor capable of being produced in high productivity, a production method thereof having high productivity, and a fuel cell system using the reactor.

According to one aspect of the present invention, a reactor is provided with: a first member including plural first projections, the first projections including gaps between the respective first projections; a second member including plural second projections, the second projections being so dimensioned as to at least partly enter into the gaps; a catalyst supported on at least a part of surfaces of the first projections and the second projections; and a case to house the first member and the second member, the case including an inflow port and an outflow port for flowing fluid.

According to another aspect of the present invention, a reactor is provided with: a first member including plural first projections, the first projections including gaps between the respective first projections; a second member including plural second projections, the second projections being so dimensioned as to at least partly enter into the gaps; a first catalyst supported on at least a part of surfaces of the first projections; a second catalyst supported on at least a part of surfaces of the second projections; and a case to house the first member and the second member, the case including an inflow port and an outflow port for flowing fluid.

According to another aspect of the present invention, a reactor is provided with: a first member including plural first projections; a second member including plural second projections, the second member and the first member being arranged so that gaps between the first projections are respectively linked with the gaps between the second projections; a first catalyst supported on at least a part of surfaces of the first projections; a second catalyst supported on at least a part of surfaces of the second projections; and a case to house the first member and the second member, the case including an inflow port and an outflow port for flowing fluid.

According to another aspect of the present invention, a fuel cell system is provided with: a reactor having; a first member including plural first projections, the first projections including gaps between the respective first projections; a second member including plural second projections, the second projections being so dimensioned as to at least partly enter into the gaps; a catalyst supported on at least a part of surfaces of the first projections and the second projections; and a case to house the first member and the second member, the case including an inflow port and an outflow port; and a fuel cell to use a gas extracted from the reactor through the outflow port to generate electricity.

According to another aspect of the present invention, a fuel cell system is provided with: a reactor having; a first member including plural first projections, the first projections including gaps between the respective first projections; a second member including plural second projections, the second projections being so dimensioned as to at least partly enter into the gaps; a first catalyst supported on at least a part of surfaces of the first projections; a second catalyst supported on at least a part of surfaces of the second projections; and a case to house the first member and the second member, the case including an inflow port and an outflow port; and a fuel cell to use a gas extracted from the reactor through the outflow port to generate electricity.

Furthermore, according to another aspect of the present invention, a fuel cell system is provided with: a reactor having; a first member including plural first projections; a second member including plural second projections, the second member and the first member being arranged so that gaps between the first projections are respectively linked with the gaps between the second projections; a first catalyst supported on at least a part of surfaces of the first projections; a second catalyst supported on at least a part of surfaces of the second projections; and a case to house the first member and the second member, the case including an inflow port and an outflow port; and a fuel cell to use a gas extracted from the reactor through the outflow port to generate electricity.

### BRIEF DESCRIPTION OF THE DRAWINGS

FIG. 1 is a schematic diagram of a fuel cell system with a reactor in accordance with a first embodiment of the present invention;

FIG. 2A is an exploded perspective view of the reactor in accordance with the first embodiment;

FIG. 2B is across sectional view taken from a line IIB-IIB of FIG. 2A;

FIGS. 3A and 3B are respectively top and front views of a micro-channel in accordance with the first embodiment;

FIG. 3C is a front view of paired micro-channel in accordance with the first embodiment;

FIGS. 4A and 4B are top views of versions of micro-channels modified from the first embodiment;

FIG. 5A is an exploded perspective view of a reactor in accordance with a second embodiment of the present invention;

FIG. 5B is a cross sectional view taken from a line VB-VB of FIG. 5A;

FIGS. 6A through 6E show versions of micro-channels modified from the second embodiment;

FIG. 7 is an exploded perspective view of a reactor in accordance with a third embodiment of the present invention;

FIG. 8A is an exploded perspective view of a reactor in accordance with a version modified from any from the first to the third embodiments;

FIG. 8B is a top view of a micro-channel in accordance with the modified version of FIG. 8A;

FIG. 9A is an exploded perspective view of a reactor in accordance with another version modified from any from the first to the third embodiments;

FIG. 9B is a top view of a micro-channel in accordance with the modified version of FIG. 9A;

FIG. 10A is an exploded perspective view of a reactor in accordance with still another version modified from any from the first to the third embodiments;

FIG. 10B is a top view of a micro-channel in accordance with the modified version of FIG. 10A;

FIGS. 11A and 11B show reactors in accordance with a working example 1;

FIG. 12 shows a reactor in accordance with a working example 2; and

FIGS. 13A and 13B show results of analysis of reformed gases.

### DETAILED DESCRIPTION OF THE INVENTION

### First Embodiment

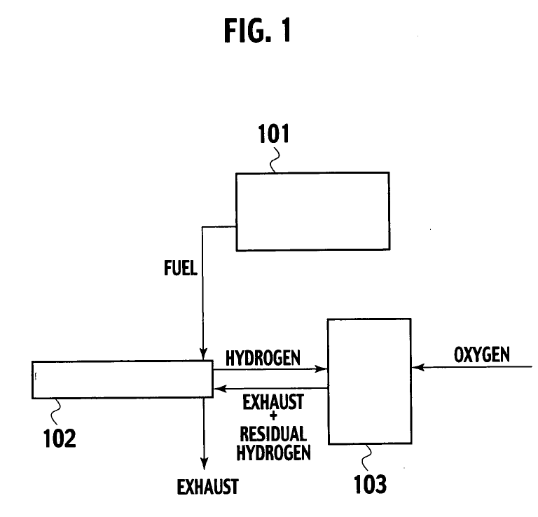

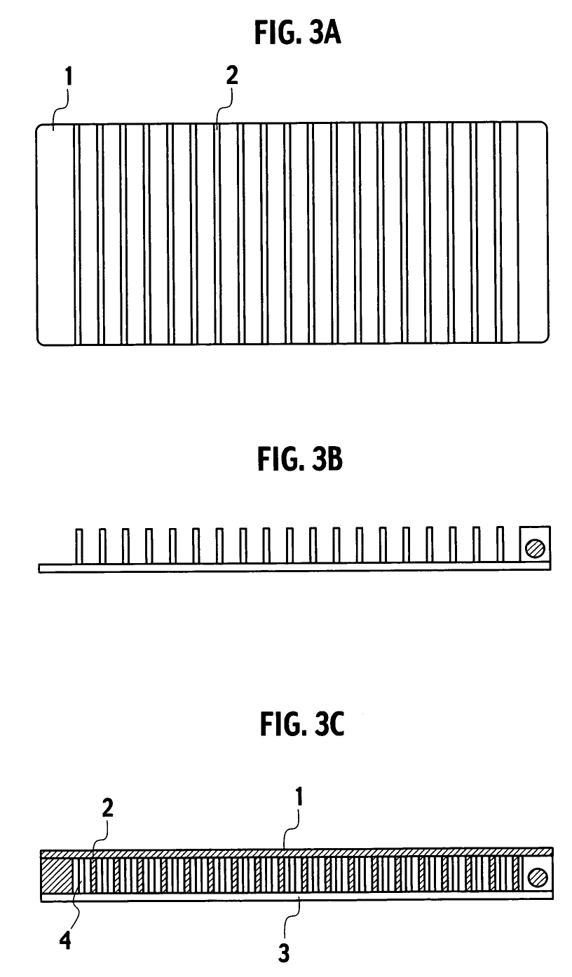

A first embodiment of the present invention will be described hereinafter with reference to FIGS. 1 to 4B.

A fuel cell system in accordance with the first embodiment is provided with a fuel tank 101, a reformer 102 and a fuel cell stack 103.

The fuel tank 101 houses a fuel for the fuel cell such as a mixture fluid of dimethyl ether (DME) and water or a mixture fluid of methanol and water. A pressure vessel configured to be detachably attached can be applied to the fuel tank 101.

The reformer 102 is linked with the fuel tank 101 via a flow line or any other appropriate means. The reformer 102 receives the fuel from the fuel tank 101 and promotes a reforming reaction of the fuel into a reformed gas containing hydrogen. The fuel may be not only in a liquid phase but also in a gas phase arisen from evaporation of the fuel. A chassis of the reformer 102 is provided with at least one reactor 100 therein, details of which will be described later. A thermally insulating container is preferably applied to the chassis of the reformer 102 in view of thermal efficiency of the fuel cell system. A chassis with a thermally insulating material and a double-walled vacuum-insulating vessel such as a so-called Dewar vessel are exemplified as the thermally insulating container.

The reformer 102 promotes a combustion reaction of hydrogen, which is left unreacted to generate electricity in the fuel cell stack 103 and exhausted therefrom, into water. Heat generated by the combustion reaction is used for filling a thermal energy required by the reforming reaction. By using the heat generated by the combustion reaction, a temperature of the reforming reaction can be regulated in a preferable range, for example at 350±50 degrees C., where the reforming reaction is effectively promoted. The temperature of the reforming reaction can be easily indirectly measured by measuring a temperature of the exterior of the reactor 100.

The fuel cell stack 103 uses the reformed gas obtained by the reformer 102 to generate electricity. The fuel cell stack 103 is provided with one or more fuel cells, each of which is composed of an anode catalyst layer, a cathode catalyst layer and a proton-conductive electrolyte layer (they are not shown in the drawings). The reformed gas is supplied to the anode catalyst layers and the air is supplied to the cathode catalyst layers, thereby the fuel cell stack 103 generates electricity.

A detailed description with respect to the reactor 100 will be given hereinafter. The reactor 100 is in general provided with a pair of micro-channels 1 and 3 (as a first member and a second member), a case 5 for housing the micro-channels 1 and 3 and a pair of lids 9 for covering a top and a bottom thereof.

The micro-channel 1 is provided with plural projections (first projections) 2 and the micro-channel 3 is provided with plural projections (second projections) 4. The projections 2 are so disposed as to correspond to respective gaps between the projections 4 and so are the projections 4. The projections 2 and 4 and the gaps therebetween are so dimensioned as to at least partly enter into each other when the micro-channels 1 and 3 are combined. In other words, the projections 2 and 4 and the gaps are dimensioned in such a way that the gaps between the projections 2 are partly partitioned by the projections 4 and the gaps between the projections 4 are partly partitioned by the projections 2.

Surfaces of the projections 2 at least partly support a reforming catalyst for a reforming reaction of the fuel such as a mixture fluid of DME and water to extract hydrogen therefrom. The reforming reaction is composed of consecutive reactions respectively represented by the following equations (1), (2) and (3). The reforming catalyst consists of, for example, γ-alumina supported on platinum (Pt).
CH₃OCH₃+H₂O→2CH₃OH (1)
CH₃OH→CO+2H₂ (2)
CO+H₂O→H₂+CO₂ (3)

The reactions of the above equations (1), (2) and (3) consecutively occur and thereby hydrogen and carbon dioxide are generated from DME and water. Ideally the reactions of (1), (2) and (3) balance so as to give an ideal composition to the reformed gas, however, provided that a rate of the reaction of the equation (3) is short of an appropriate level, a certain content of carbon monoxide is left in the reformed gas. The carbon monoxide gives rise to deterioration of the fuel cell stack 103. Moreover, methanol generated in an excessive concentration inhibits the reaction of (1) and carbon monoxide generated in an excessive concentration inhibits the reaction of (2).

To reduce the concentration of carbon monoxide, the surfaces of the projections 4 at least partly support a shift catalyst for a shift reaction of carbon monoxide with water molecule to shift oxygen from water molecule to carbon monoxide, which is represented by the following equation (4).
CO+H₂O→H₂+CO₂ (4)

The shift catalyst supported on the projections 4 promotes the shift reaction so as to reduce the concentration of carbon monoxide and hence the reaction of (2) is promoted. Thereby the concentration of methanol is reduced so that the reaction of (1) is promoted.

The case 5 is provided with a fitting portion 10, which is a cavity formed in the case 5 and the micro-channels 1 and 3 are fitted into. A combination of the fitting portion 10 and the micro-channels 1 and 3 is so dimensioned as to form flow paths therein for allowing a fluid to flow therethrough. The lids 9 are set on the top and the bottom of the case 5 after fitting the micro-channels 1 and 3 therein. The fitting portion 10 is so configured as to form flow paths therein by sealing the fitting portion 10, and, as need arises, joining of the micro-channels 1 and 3 with the case 5 and/or the lids 9 with the case 5 may be accomplished to seal the fitting portion 10.

The case 5 is further provided with an inflow port 6 and an outflow port 7. A fluid, namely the fuel in the present embodiment, is supplied through the inflow port 6to the reactor 100. Another fluid, namely a mixture gas (a reformed gas) of hydrogen, unreacted fuel and any product gases generated by the reforming reaction and the shift reaction in the present embodiment, is extracted through the outflow port 7 to the exterior of the reactor 100.

The lids 9 are formed from a base material by machining and, preferably, at least in part, made of any highly thermally conductive base material for improvement of thermal conductivity. As such a base material, aluminum, copper, aluminum alloys and copper alloys can be exemplified. Stainless steels are also preferable as the base material because of its excellent corrosion resistance which leads to long-term applicability of the micro-channels 1 and 3, though the thermal conductivity is not so high as compared with the above materials.

A detailed description with respect to the micro-channels 1 and 3 will be given hereinafter. First, a description is made to the micro-channel 1. The micro-channel 1 is formed from a mass of base material by machining. Since higher thermal conductivity is preferable at a time of catalytic reaction, the micro-channel 1 is preferably, at least in part, made of any highly thermally conductive base material for improvement of thermal conductivity. As such a base material, aluminum, copper, aluminum alloys and copper alloys can be exemplified. As well, these materials are further preferable in view of machinability. Stainless steels are also preferable as the base material because of its excellent corrosion resistance which leads to long-term applicability of the micro-channel 1, though the thermal conductivity is not so high as compared with the above materials.

The micro-channel 1 is, as mentioned above, provided with the plural projections 2 on one of both faces. The projections 2 are formed in fin-like shapes and disposed substantially in parallel with each other. The projections 2 are preferably formed by a usual machining method or a usual forming method.

As an example of usual machining, electrical discharge machining using a wire (wire-cutting) can be exemplified. The wire-cutting is accomplished by generating electrical discharge between a tool electrode of a thin metal wire and an object for machining and moving the tool electrode or the object correspondingly to an objective shape. Alternatively, abrasive machining using a disc blade made of abrasive particles such as diamond particles solidified with resin can be applied. The abrasive machining is accomplished by rotating the disc blade at high speed and then touching and moving the disc blade to an object so that portions where the rotating disc blade touches are worn off to give an objective shape. The wire-cutting and the abrasive machining are very adapted to forming projections having a high aspect ratio, such as the projections 2, in a short time. Alternatively, the usual machining method can be applied in combination with the other forming methods. As the other forming methods, forging (described later), casting and extruding are exemplified.

As an example of usual forming, forging can be exemplified. Forging is accomplished by pressing and deforming a bar or a bulk of metal with a die or a tool so that the bar or the bulk forms an objective shape. The forging provides the metal with hardening so as to improve mechanical properties thereof, as well as deformation of the metal so as to obtain an objective shape. Alternatively, casting can be applied. The casting is accomplished by pouring molten metal into a casting die having a cavity of an objective shape and removing the casting die after enough cooling so that the objective shape of the metal is obtained. The forging and the casting are very adapted to forming complex shapes such as the micro-channel 1 of the present embodiment.

Surfaces of the projections 2 at least in part, for example at wall surfaces thereof respectively facing to the adjacent projections 2, support a catalyst (a first catalyst). In a case where the reactor 100 is used as a reformer for reforming methanol and/or DME to extract hydrogen therefrom, the first catalyst may include the reforming catalyst for the reforming reaction.

Forming the catalyst supported on the wall surfaces of the projections 2 is accomplished by the following steps. In a case where the surfaces of the micro-channel 1 are formed of aluminum or an aluminum alloy, the surfaces of the micro-channel 1 are anodized. The anodized surfaces are next subject to any of publicly known methods as forming a catalyst layer on a support, for example awash-coating method, a sol-gel method and an impregnation method, to form the catalyst supported on the anodized wall surfaces of the projections 2. In a case where the surfaces of the micro-channel 1 are formed of a stainless steel, the micro-channel 1 is baked at a high temperature so that roughness of the surfaces of the micro-channel 1 including the inner surfaces of the projections 2 is increased. The surfaces having greater roughness are next subject to a publicly known method for forming a catalyst layer on a support described above to form the catalyst supported on the surfaces.

Next, a description of the micro-channel 3 is given. The micro-channel 3 is formed from a mass of base material by machining. The micro-channel 3 is preferably, at least in part, made of any highly thermally conductive base material for improvement of thermal conductivity, similarly to the micro-channel 1.

The micro-channel 3 is, as mentioned above, provided with the plural projections 4 on one of both faces. The projections 4 are formed in fin-like shapes and disposed substantially in parallel with each other. The projections are preferably formed by a usual machining method or a usual forming method similarly to the micro-channel 1.

Surfaces of the projections 4 at least in part, for example at wall surfaces thereof respectively facing to the adjacent projections 2, support a catalyst (a second catalyst). In a case where the reactor 100 is used as a reformer for reforming methanol and/or DME to extract hydrogen therefrom, the second catalyst may include the shift catalyst for the shift reaction. Forming the catalyst supported on the wall surfaces of the projections 4 is accomplished by similar steps to the aforementioned steps for the first catalyst supported on the projections 2.

A detailed description with respect to the case 5 will be given hereinafter. The case 5 is formed from a mass of base material by machining. Similar to the micro-channels 1 and 3, the case 5 is preferably, at least in part, made of any highly thermally conductive base material for improvement of thermal conductivity. The case 5 is, as mentioned above, provided with the fitting portion 10, which is the cavity formed in the case 5. The fitting portion 10 is preferably formed by a usual machining method or a usual forming method from the base material of the case 5.

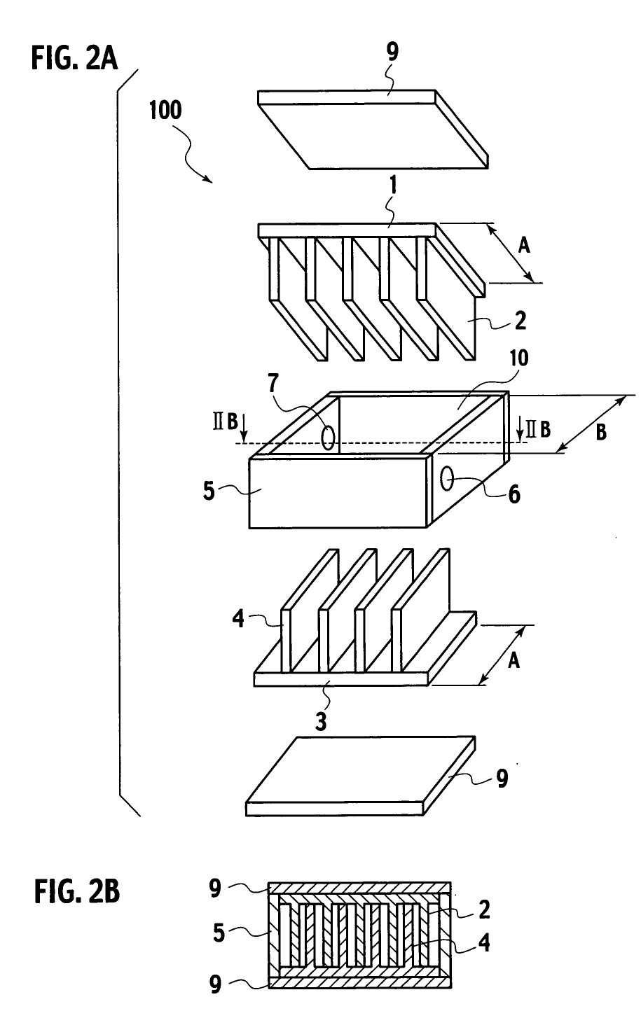

The micro-channels 1 and 3 are fitted into the fitting portion 10 of the case 5 as mentioned above. The fitting portion 10 and the micro-channels 1 and 3 are so dimensioned that a width of the fitting portion 10, denoted by B in FIG. 2A, is greater than a length of flow paths formed by the micro-channels 1 and 3, denoted by A in FIG. 2A. Spaces are formed between the fitting portion 10 and the micro-channels 1 and 3 and the inflow port 6 is provided so as to link with one of the spaces. Moreover, the outflow port 7 is provided so as to link with another one of the spaces.

A detailed description with respect to assembly of the micro-channels 1 and 3 with the case 5 will be given hereinafter. For example, welding may be accomplished for joining and sealing the case 5 with the lids 9. However, any extremely high temperature in the course of the welding may give rise to sintering of the catalyst supported on the micro-channels 1 and 3. Here, “sintering” means fusion of particles of the catalyst to form larger particles and hence leads to decrease in exposed surface area of the catalyst, namely decrease in number of active sites on the catalyst, and change in surface structure of the catalyst. (see “SHOKUBAI-KOZA volume 5th, VOLUME OF OPTICS 1, CATALYST DESIGN”, edited by CATALYSIS SOCIETY of JAPAN, published by KODANSHA on Dec. 10, 1985)

Provided that the catalyst is subject to sintering, catalytic activity may decrease. Therefore, the welding at when joining the lids 9 with the case 5 is preferably achieved in such a way that a temperature of the catalyst does not reach a sintering temperature where the catalyst is sintered. For example, a catalyst containing Pt has a sintering temperature not so greater than 500 degrees C. Any welding method capable of local heating with respect to joining portions between the lids 9 and the case 5, such as laser-beam-welding or ultrasonic-welding, is preferably employed.

Moreover, preferably, conditions of the laser-beam-welding or the ultrasonic-welding are preferably regulated so that the temperature of the catalyst containing Pt does not reach the sintering temperature of 500 degrees C. Provided that aluminum of A1050 regulated in JIS regulation is applied to the micro-channels 1 and 3, case 5 and the lids 9, laser-beam-welding of the lids 9 with the case 5 may be accomplished in the following conditions. According to the inventors' experiment, a YAG laser apparatus (600 W in output power, 1 μm diameter of a laser beam) was applied to a welding apparatus. The conditions were regulated to be 520 W in peak value, 100 W in every pulse, 10 pulses per second and then laser-beam-welding was achieved. In the course of welding, the temperature of the catalyst was constantly below 500 degrees C. and an overlap ratio of seams is less than 70%, thereby good welding could be accomplished.

Alternatively, ultrasonic-welding of the lids 9 with the case 5 may be accomplished in the following conditions. According to the inventors' experiment, an oscillator of 3 kW in output power and 20 kHz in frequency was applied to a welding apparatus. A horn was pressed to a portion objective to welding with a facial pressure of 3 to 4 kgf/cm² and an ultrasonic wave was applied for 0.6 sec. In the course of welding, the temperature of the catalyst was constantly below 500 degrees C. and good welding could be accomplished.

In accordance with the present embodiment, after combining the micro-channels 1 and 3, intervals between the projections 2 and the adjacent projections 4 respectively form flow paths, widths of which are necessarily below halves of the gaps of the projections 2 and 4. More specifically, flow paths having relatively high aspect ratios can be formed from gaps between the respective projections 2 and 4 having relatively low aspect ratios, in high productivity, where an aspect ratio is defined as a ratio of a length to a width of a flow path or a gap.

Moreover, two different catalysts may be individually supported on the micro-channel land the micro-channel 3. When a chemical reaction goes near to equilibrium, a reaction rate of a reverse reaction comes near to a reaction rate of a forward reaction and hence change in composition ratios of start substances to product substances decreases. Therefore, for example, if the reaction of the equation (1) would be promoted, the reaction of the equation (2) should be promoted. Similarly, if the reaction of the equation (2), the reactions of the equations (3) and (4) should be promoted. Therefore, to bring about consecutive reactions as the present embodiment, it is preferable that catalysts respectively corresponding to the consecutive reactions are disposed alternately so that product substances (for example, carbon monoxide) of one catalyst (for example, the reforming catalyst) promptly come to be in contact with the next catalyst (for example, the shift reaction). The constitution in which two different catalysts are individually supported on the micro-channels 2 and the micro-channels 4 can effectively realize such a preferable situation for the consecutive reactions.

Moreover, the above constitution may contribute elongation of lives of the catalysts. Provided that any of product substances of a former reaction in the consecutive reactions may influence a catalyst thereof, the non-preferable product substance can be promptly decreased by a next reaction. Therefore the above constitution can elongate a life of the reactor.

Furthermore, the micro-channels 1 and 3 of the present embodiment have the relatively wide gaps between the respective projections 2 and 4 before combining the micro-channels 1 and 3 with each other, as compared with the relatively narrow flow paths formed after combining. The relatively wide gaps are favorable to form supported catalyst layers on the micro-channels 1 and 3 since the gaps are unlikely clogged with catalyst slurry including binder. More specifically, the reactor can be produced with a high yield ratio.

According to the inventors' experiment of forming the catalyst layer supported on the surfaces of the projections 2 by a wash-coating method, the projections 2 tended to be clogged with the catalyst slurry in a case where the gaps of the projections 2 are less than 1.0 mm in width. On the contrary, in a case where a pitch between the respective projections 3 of the micro-channels 1 is 1.5 mm and a width of the projections 3 is 0.5 mm and a pitch between the respective projections 4 of the micro-channels 2 is 1.5 mm and a width of the projections 4 is 0.5 mm, which leads to forming flow paths of 0.5 mm in width, clogging can be avoided and hence the reactor can be produced in a high yield ratio.

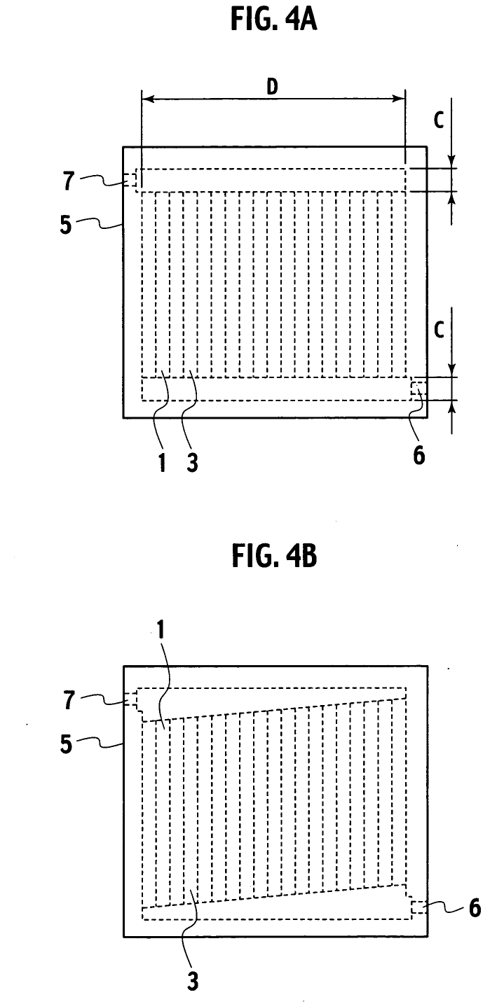

While the spaces formed between the fitting portion 10 and the micro-channels 1 and 3, which are denoted by C in FIG. 4A, are substantially even in width according to the above-described present embodiment of the present invention, it can be modified so that the widths are made greater around the inflow port 6 and the outflow port 7 and decrease with distances from the inflow port 6 and the outflow port 7 as shown in FIG. 4B. This modification reduces unevenness of pressures respectively applied to the plural flow paths and hence more effectively promotes the reaction occurring in the reactor.

Moreover, it is preferable that flows of the fluid through the inflow port 6 and the outflow port 7 form angles with flows through the respective flow paths (FIGS. 4A and 4B illustrate an example of perpendicularity), unevenness of pressures applied to the respective flow paths is further reduced and more effective promotion of the reaction can be obtained.

### Second Embodiment

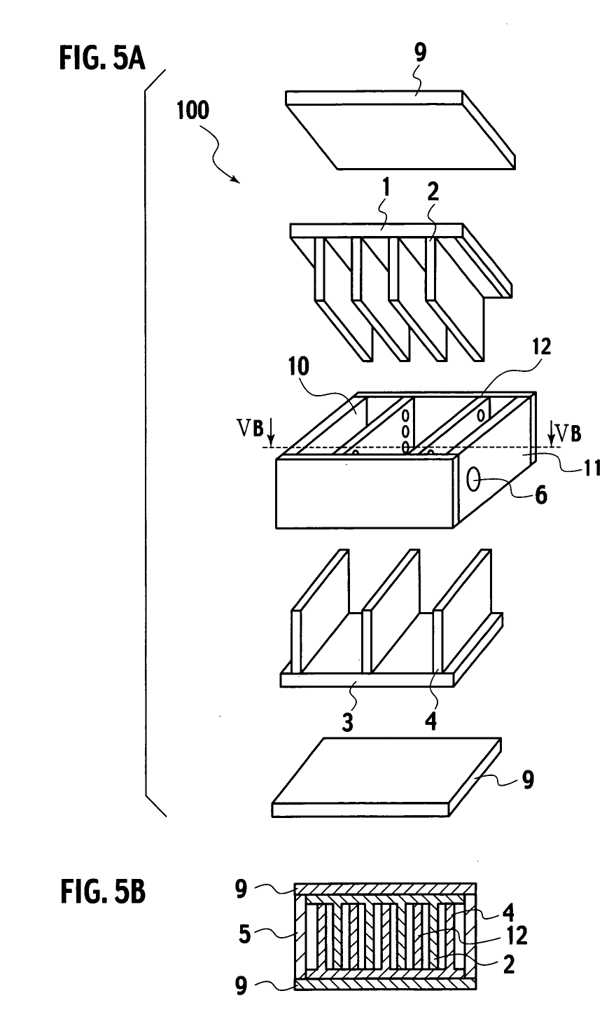

A second embodiment of the present invention will be described hereinafter with reference to FIGS. 5A and 5B. In the following description, substantially the same elements as any of the aforementioned elements will be referenced with the same numerals and the detailed descriptions thereof will be omitted.

The reactor 100 in accordance with the second embodiment is in general provided with a micro-channel (first member) 1, a micro-channel (second member) 3, a case 11 for housing the micro-channels 1 and 3 and a pair of lids 9 for covering a top and a bottom thereof.

The micro-channels 1 and 3 are formed from a base material by machining. The micro-channel 1 is provided with plural projections (first projections) 2 and the micro-channel 3 is provided with plural projections (second projections) 4. In contrast to the aforementioned first embodiment, the projections 2 or 4 are not so completely disposed as to correspond to gaps of the counterpart projections. In an illustration shown in FIG. 5A, the micro-channel 3 misses two projections corresponding to gaps, one of which is between the first and second projections 2 and another of which is between the third and fourth projections. When combining the micro-channels 1 and 3 with intervening the case 11, fins 12 (described later) of the case 11 come to spaces corresponding to the missing projections.

Surfaces of the projections 2 at least partly support a reforming catalyst for a reforming reaction of the fuel such as a mixture fluid of DME and water to extract hydrogen therefrom. The reforming reaction is composed of consecutive reactions respectively represented by the aforementioned equations (1), (2) and (3). Surfaces of the projections 4 at least partly support a shift catalyst for a shift reaction of carbon monoxide with water molecule to shift oxygen from water molecule to carbon monoxide, which is represented by the aforementioned equation (4).

The case 11 is provided with a fitting portion 10, which is a cavity formed in the case 11 and the micro-channels 1 and 3 are fitted into. A combination of the fitting portion 10 and the micro-channels 1 and 3 is so dimensioned as to form flow paths therein for allowing a fluid to flow therethrough. The case 11 is further provided with one or more fins 12 correspondently to the missing projections of the micro-channel 3. Surfaces of the fins 12 at least partly support the reforming catalyst or a methanation catalyst for methanating carbon oxide, which may be left unreacted in the shift reaction represented by the aforementioned equation (4), into methane. As the methanation catalyst, a selective methanation catalyst which selectively promotes the methanation reaction of (5) more effectively than a methanation reaction of carbon dioxide, can be used.
CO+3H₂→CH₄+H₂O (5)

The case 11 is further provided with an inflow port 6 and an outflow port 7 (hidden behind any member in FIG. 5A). A fluid, namely the fuel in the present embodiment, is supplied through the inflow port 6 to the reactor 100. Another fluid, namely a mixture gas (a reformed gas) of hydrogen, unreacted fuel and any product gases generated by reactions brought about in the reactor 100 in the present embodiment, is extracted through the outflow port 7 to the exterior of the reactor 100.

The projections 2 and 4 and the gaps therebetween are so dimensioned as to at least partly enter into each other when the micro-channels 1 and 3 are combined. Moreover, as in combination with the projections 4, the fins 12 are so dimensioned as to at least partly enter into the projections 4 correspondingly to the missing projections of the multi-channel 3. The projections 2 and 4 and the fins 12 are so dimensioned as to partition the interior of the case 11 to form flow paths therebetween, through which the fluid flows from the inflow port 6 to the outflow port 7.

Production method of the micro-channels 1 and 3 and the case 11 in accordance with the present second embodiment is substantially the same as the aforementioned first embodiment.

In accordance with the present second embodiment, after combining the micro-channels 1 and 3 and the case 11, the flow paths formed among the projections 2 and 4 and the fins 12 have widths below halves of the gaps of the projections 2 and 4. More specifically, flow paths having relatively high aspect ratios can be formed by combining the micro-channels 1 and 3 and the case 11 in high productivity, where an aspect ratio is defined as a ratio of a length to a width of a flow path.

Moreover, two or more different catalyst may be individually supported on the micro-channel 1, the micro-channel 3 and the case 11. In a case of using the reactor 100 to bring about consecutive reactions, the catalysts respectively promote the reactions and product substances (for example, carbon monoxide) of one catalyst (for example, the reforming catalyst) promptly come to be in contact with the next catalyst (for example, the shift reaction), thereby the consecutive reactions are effectively promoted.

Moreover, the above constitution may contribute elongation of lives of the catalysts because any product substance non-preferable for one catalyst can be promptly decreased by a next catalyst.

Furthermore, the micro-channels 1 and 3 and the case 11 of the present embodiment have the relatively wide gaps between the respective projections 2 and 4 and between the fins 12 before combining the micro-channels 1 and 3 with each other, as compared with the relatively narrow flow paths formed after combining. The relatively wide gaps are favorable to form supported catalyst layers on the micro-channels 1 and 3 and the case 11 since the gaps are unlikely clogged with catalyst slurry including binder. More specifically, the reactor can be produced with a high yield ratio.

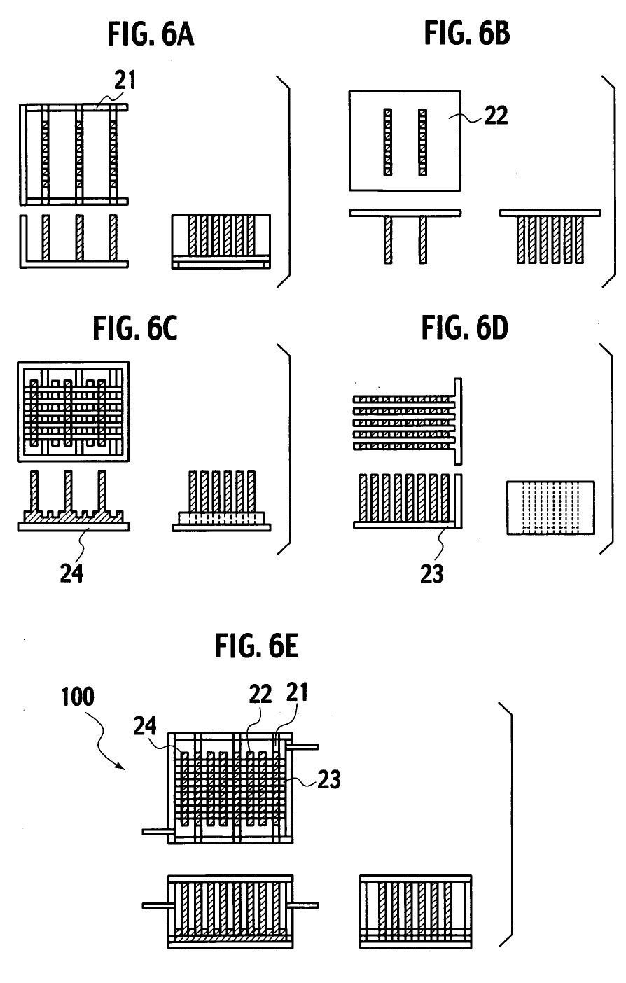

The reactor 100 may be composed of more than three members, though the aforementioned description refers to an illustration for three members of two micro-channels and the case. For example, as shown in FIGS. 6A through 6E, the reactor 100 may be composed of three micro-channels 21, 22 and 23 and the case 24. The four members may individually support four different catalysts. This constitution provides better applicability for more various reactions.

Alternatively, any two of the four members may support a common catalyst and hence the four members support only three catalysts. For example, catalysts A, B, C may be supported so as to be arranged in such a way as “A-B-A-B-C” with respect to a direction of the flow. Further for example, the catalyst A, B, C may be respectively the reforming catalyst, the shift catalyst and the selective methanation catalyst. Such an arrangement provides more effective promotion of the reactions.

Similarly to the aforementioned first embodiment, width of between the fitting portion 10 and the micro-channels 1 and 3 may be modified in such a way that the widths are made greater around the inflow port 6 and the outflow port 7 and decrease with distances from the inflow port 6 and the outflow port 7 as shown in FIG. 4B. Moreover, the micro-channels 1 and 3 and the case 11 may be modified in such a way that flows of the fluid through the inflow port 6 and the outflow port 7 form angles with flows through the respective flow paths. Interior apertures of the inflow port 6 and the outflow port 7 may be disposed outside with respect to regions where the flow paths link with the spaces between the fitting portion 10 and the micro-channels 1 and 3.

### Third Embodiment

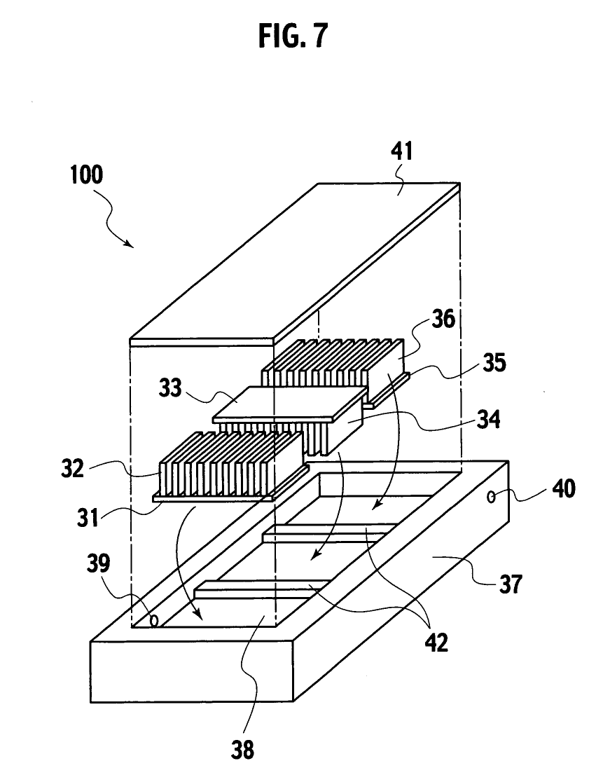

A third embodiment of the present invention will be described hereinafter with reference to FIG. 7. In the following description, substantially the same elements as any of the aforementioned elements will be referenced with the same numerals and the detailed descriptions thereof will be omitted.

The reactor 100 in accordance with the third embodiment is in general provided with a micro-channel (first member) 31, a micro-channel (second member) 33, a micro-channel 35, a case 37 for housing the micro-channels 31, 33 and 35 and a lid 41 for covering a top thereof.

The micro-channels 31, 33 and 35 are formed from a base material by machining. The micro-channel 31 is provided with plural projections 34. Grooves between the projections 34 penetrate from one side to the other side of the micro-channel 31. The base material, the machining method and the catalyst supported thereon are substantially the same as the aforementioned first embodiment and detailed descriptions thereof are omitted. The micro-channels 33 and 35 are formed in a similar way.

Moreover the projections 32, 34 and 36 are formed, particularly in view of these widths and intervals therebetween, so as to correspond to each other when the micro-channels 31, 33 and 35 are arranged in an end-to-end disposition as shown in FIG. 7. Then grooves between the respective projections 32, grooves between the respective projections 34 and grooves between the respective projections 36 are mutually linked.

The case 37 is provided with a fitting portion 38, which is a cavity formed in the case 37 and the micro-channels 31, 33 and 35 are fitted into. A combination of the fitting portion 38 and the micro-channels 31, 33 and 35 is so dimensioned as to form flow paths therein for allowing a fluid to flow therethrough. The case 37 receives a lid 41 thereon so as to be sealed, and, as need arises, joining of the micro-channels 31, 33 and 35 with the case 37 and/or the lids 41 with the case 37 may be accomplished.

The case 37 is further provided with an inflow port 39 and an outflow port 40 so as to allow the fluid to flow from the inflow port 39 through the flow paths formed in the case 37 to the out flow port 40. When the fitting portion 38 in which the micro-channels 31, 33 and 35 are fitted is sealed with the lid 41, the reactor 100 having parallel flow paths therein is formed. Production method of the micro-channels 31, 33 and 35 and the case 37 in accordance with the present third embodiment is substantially the same as the aforementioned first and second embodiments.

The lid 41 is formed from a base material by machining and, preferably, at least in part, made of any highly thermally conductive base material for improvement of thermal conductivity. As such a base material, aluminum, copper, aluminum alloys and copper alloys can be exemplified. Stainless steels are also preferable as the base material because of its excellent corrosion resistance which leads to long-term applicability of the micro-channels 1 and 3, though the thermal conductivity is not so high as compared with the above materials.

To seal the fitting portion 38 with the lid 41, joining the case 37 and the lid 41 by welding may be accomplished. However, as mentioned above, sintering would be preferably avoided in view of maintaining catalytic activity of catalysts therein. Therefore the joining method described in the description for the first embodiment should be also applied to the present embodiment.

Different catalyst may be individually supported on the micro-channels 31, 33 and 35. In a case of using the reactor 100 to bring about consecutive reactions, the catalysts respectively promote the reactions and product substances (for example, carbon monoxide) of one catalyst (for example, the reforming catalyst) promptly come to be in contact with the next catalyst (for example, the shift reaction), thereby the consecutive reactions are effectively promoted.

Moreover, the above constitution may contribute elongation of lives of the catalysts because any product substance non-preferable for one catalyst can be promptly decreased by a next catalyst.

Furthermore, the flow paths in the reactor 100 are free from bottleneck portions for flow of the fluid where cross sections thereof drastically decrease since grooves between the respective projections 32, grooves between the respective projections 34 and grooves between the respective projections 36 are mutually linked. Therefore pressure drop for the flow of the fluid can be suppressed and hence the reactions occurring in the reactor 100 can be effectively promoted.

Moreover the absence of the bottleneck portions for the flow of the fluid provides suppression of possibility of clogging of the flow paths and hence decreases possibility of a malfunction of the reactor 100.

The micro-channels 31, 33 and 35 may be disposed so that any of the projections 32, 34 and 36 project in a different direction from the others. For example, as shown in FIG. 7, the micro-channel 33 disposed between the micro-channels 31 and 35 may be directed downward though the others are directed upward. Each of the micro-channels 31, 33 and 35 is not symmetrical since each of the projections 32, 34 and 36 exists only in one side thereof. The asymmetry may cause deformation when the micro-channels 31, 33 and 35 are subject to high temperatures. Further, extreme deformation gives rise to back-flow without contact with the catalyst, where the term “back-flow” means a flow through a back side of any of the micro-channels where the projections supporting the catalysts do not exist. The disposition that any of the micro-channels 31, 33 and 35 is directed in a different direction from the others provides suppression of such deformation.

The case 37 may be further provided with ribs 42 between the micro-channels 31 and 33 and between the micro-channels 33 and 35 so as to slightly detach the micro-channels 31, 33 and 35 from each other. The detachment suppresses a range of fluctuation in pressure distributions among the flows through the respective grooves between the projections 32, 34 and 36 and hence suppresses biases of the flows. The ribs 42 in addition suppress the back-flow when deformation occurs to the micro-channels 31, 33 and 35.

Modifications and variations of the embodiments described above will occur to those skilled in the art.

For example, the projections 2 and 4 in accordance with the first embodiment shown in FIG. 1 are formed in fin-like shapes, each of which has a length in the longitudinal direction as substantially same as the width (denoted by A in the drawing) of each of the micro-channels 1 and 3. However, any of shapes may be given to the projections 2 and 4 as long as they are so dimensioned as to at least partly enter into each other when the micro-channels 1 and 3 are combined.

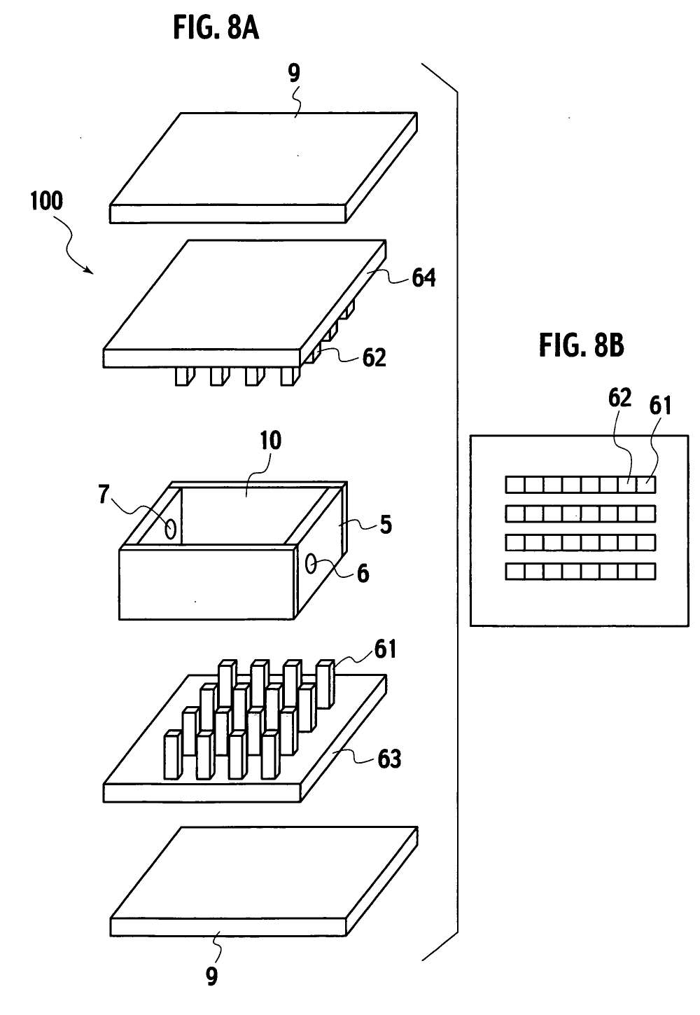

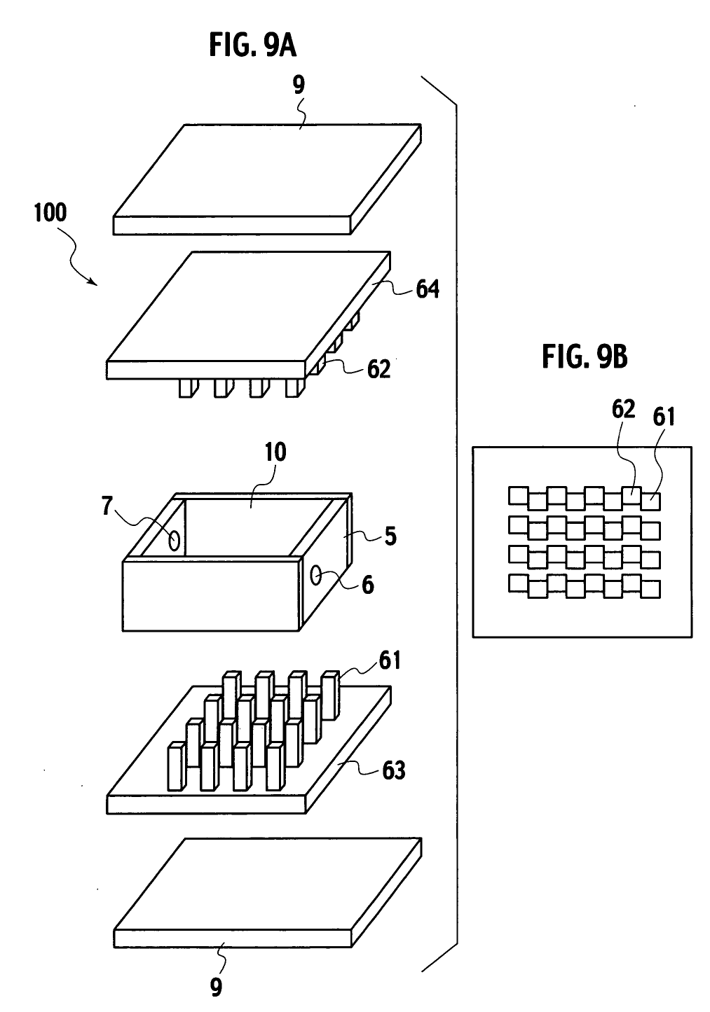

For example, micro-channels 63 and 64 respectively having pin-shaped projections 61 and 62 shown in FIGS. 8A and 8B may be applied to the reactor 100. The pin-shaped projections 61 and 62 are so formed as to mesh with each other like and be lined up like as planes shown in FIG. 8B. Alternatively, the pin-shaped projections 61 and 62 are so formed as to be lined up in zigzag planes as shown in FIGS. 9A and 9B. The latter constitution provides a larger area for contact of the fluid with the catalyst supported thereon and hence the reaction is effectively promoted.

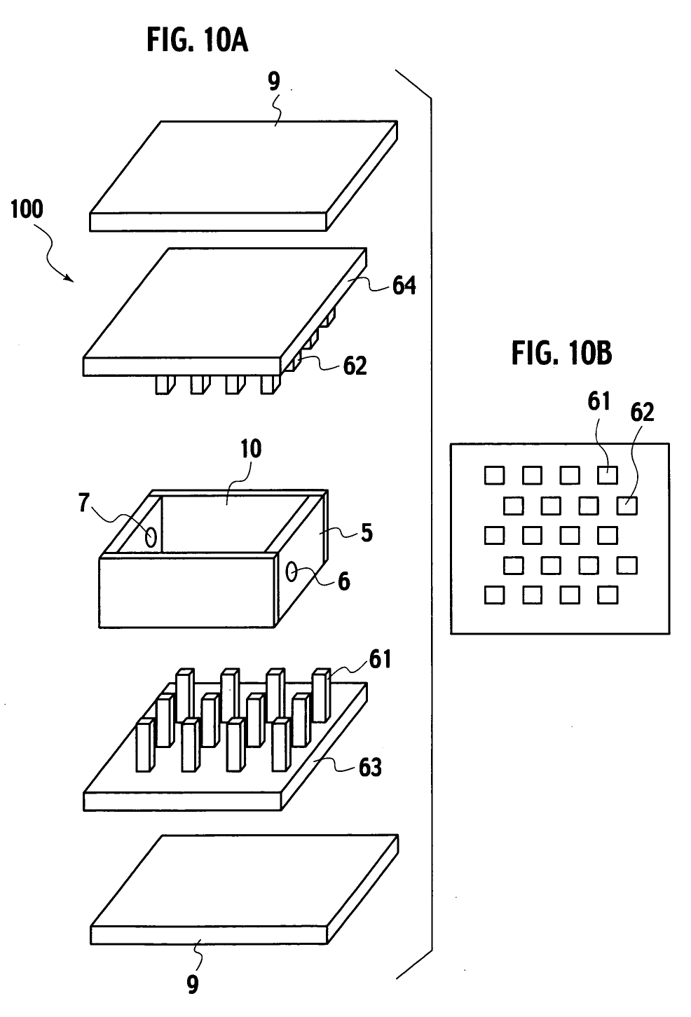

The pin-shaped projections 61 and 62 are not necessarily in contact with each other. As shown in FIG. 10, the pin-shaped projections 61 and 62 may be detached.

Moreover, a combined constitution derived from the first embodiment and the third embodiment may be applied. Any micro-channel may be added to the combination of the micro-channels 31, 33 and 35 shown in FIG. 7 so as to partly enter projections of the added micro-channel into the projections 32, 34 or 36 of the micro-channel 31, 33 or 35.

Moreover, the aforementioned embodiments uses the catalyst for promoting the reactions, however, any catalyst for suppressing any reaction can be applied. Such constitution improves balance among the consecutive reactions, for example the reactions represented by the equations (1), (2) and (3), in a case where a rate of any of the reactions is too great in view of rates of the other reactions.

### WORKING EXAMPLE 1

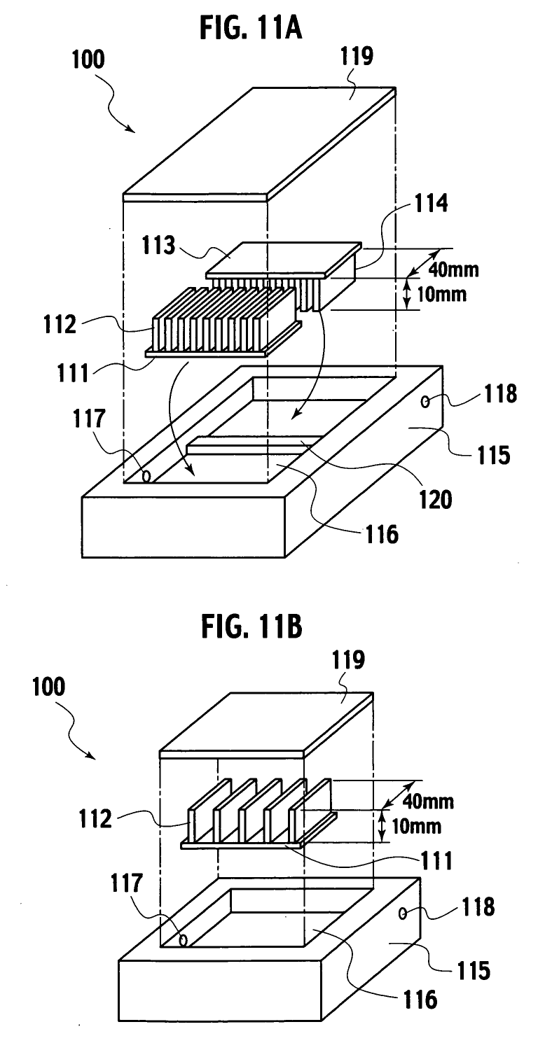

An experiment of measuring compositions of gases reformed from DME and vaporized water in a reactor was carried out with respect to the reactor shown in FIG. 11A. The micro-channel 111 supports the reforming catalyst and the micro-channel 113 supports the shift catalyst. With respect to the numbers of the projections 112 and 114, illustration of FIG. 11A are not strict for purposes of convenience. The numbers were set so that A/F as an index in place of a spatial speed SV as the conventional index for a catalyst filling layer was 3.5 cm²/sCcm, where A represents an apparent surface area (cm²) of the catalyst and F represents a flow rate (sccm) of DME. Sccm represents a unit of flow rate measured in mL per min., in which a volume of a gas is converted into one of a standard condition (0 degrees C., 1 atm). A temperature of the reactor measured by a surface thermometer attaching on the case 115 was 350 degrees C.

### COMPARATIVE EXAMPLE

As a comparative example, measurement of compositions of gases reformed from DME and vaporized water extracted from a reactor shown in FIG. 11A was carried out. The micro-channel 111 supports the reforming catalyst. The number of the projections 12 was set so that A/F was cm²/sccm.

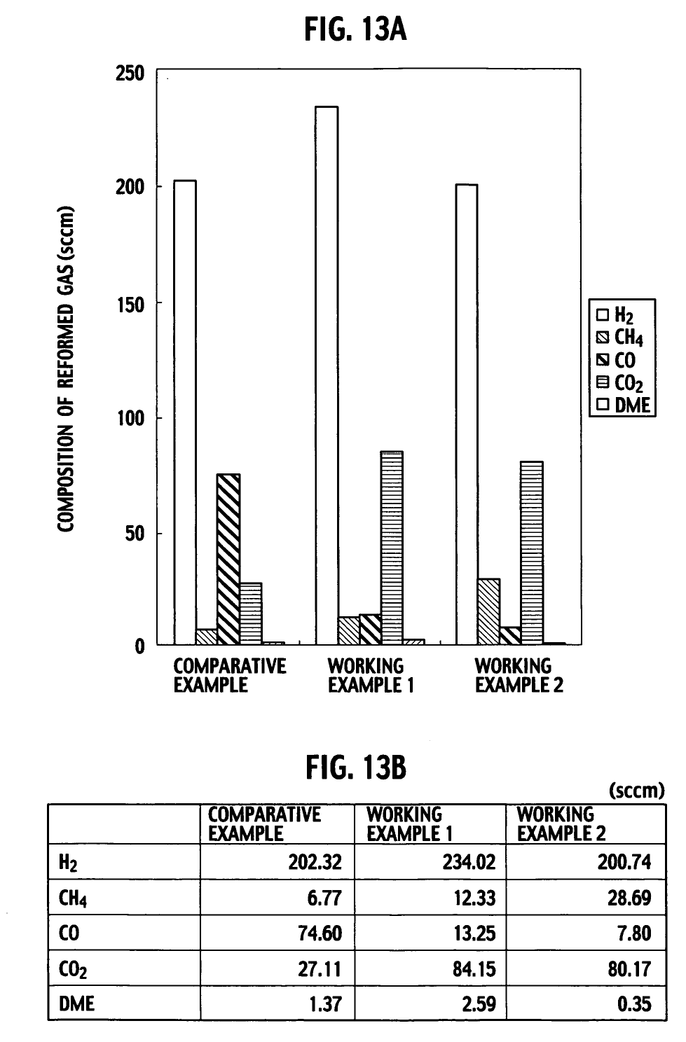

The measured compositions are shown in FIGS. 13A and 13B. As being understood from FIGS. 13A and 13B, the reformed gas obtained from the working example contains far smaller amount of carbon monoxide than the reformed gas obtained from the comparative example. This is led from effective promotion of the consecutive reactions of the equations (1) to (4) derived from the constitution of the working example, in which grooves between the respective projections 112 and grooves between the respective projections 114 are mutually linked.

### WORKING EXAMPLE 2

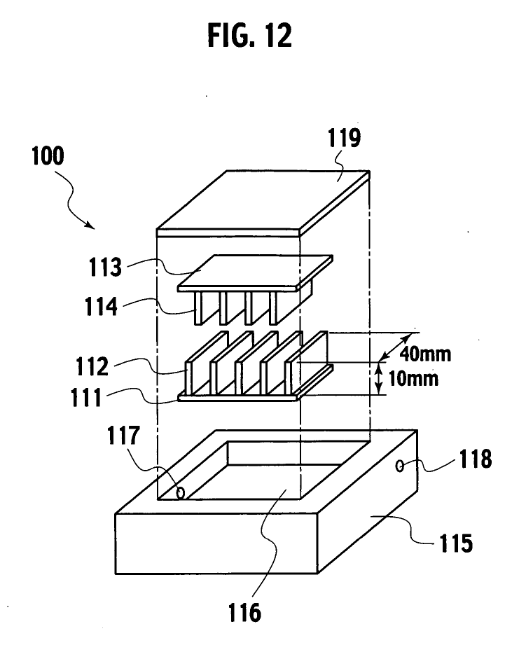

Measurement of compositions of gases reformed from DME and vaporized water extracted from a reactor shown in FIG. 12 was carried out. The micro-channel 111 supports the reforming catalyst and the micro-channel 113 supports the shift catalyst. With respect to the numbers of the projections 112 and 114, illustration of FIG. 12 are not strict for purposes of convenience. The numbers were set so that A/F as an index in place of a spatial speed SV as the conventional index for a catalyst filling layer was 3.5 cm²/sccm, where A represents an apparent surface area (cm²) of the catalyst and F represents a flow rate (sccm) of DME. A temperature of the reactor was 350 degrees C.

### COMPARATIVE EXAMPLE

As a comparative example, measurement of compositions of gases reformed from DME and vaporized water extracted from a reactor shown in FIG. 11A was carried out.

The measured compositions are shown in FIGS. 13A and 13B. As being understood from FIGS. 13A and 13B, the reformed gas obtained from the working example 2 contains far smaller amount of carbon monoxide than the reformed gas obtained from the comparative example. This is led from effective promotion of the consecutive reactions of the equations (1) to (4) derived from the constitution of the working example 2, in which the projections 112 and 114 and the gaps therebetween are so dimensioned as to mutually enter in each other.

As comparison between the working example 1 and the working example 2, the reformed gas obtained from the working example 1 contains far smaller amount of carbon monoxide than the reformed gas obtained from the working example 2. The reason is thought to be that unintended reactions represented by the following equations (6) and (7) are suppressed in the reactor of the working example 1 as compared with the working example 2.
CO+3H₂→CH₄+H₂O (6)
CO₂+4H₂→CH4+2H₂O (7)

Therefore, it should be estimated that the reactor of the working example 1 suppresses formation of hydrogen as compared with the working example 2 and more effectively promotes the consecutive reactions of (1) to (3).

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A reactor comprising:
a first member including plural first projections, the first projections including gaps between the respective first projections;
a second member including plural second projections, the second projections being so dimensioned as to at least partly enter into the gaps;
a catalyst supported on at least a part of surfaces of the first projections and the second projections; and
a case to house the first member and the second member, the case including an inflow port and an outflow port for flowing fluid.

2. A reactor comprising:
a first member including plural first projections, the first projections including gaps between the respective first projections;
a second member including plural second projections, the second projections being so dimensioned as to at least partly enter into the gaps;
a first catalyst supported on at least a part of surfaces of the first projections;
a second catalyst supported on at least a part of surfaces of the second projections; and
a case to house the first member and the second member, the case including an inflow port and an outflow port for flowing fluid.

3. A reactor comprising:
a first member including plural first projections;
a second member including plural second projections, the second member and the first member being arranged so that gaps between the first projections are respectively linked with the gaps between the second projections;
a first catalyst supported on at least a part of surfaces of the first projections;
a second catalyst supported on at least a part of surfaces of the second projections; and
a case to house the first member and the second member, the case including an inflow port and an outflow port for flowing fluid.

4. The reactor of claim 2, wherein the first catalyst is to promote a first catalytic reaction and the second catalyst is to promote a second catalytic reaction of a product substance generated by the first catalytic reaction.

5. The reactor of claim 4, wherein the first projections and the second projections are disposed alternately.

6. The reactor of claim 3, wherein the first catalyst is to promote a first catalytic reaction and the second catalyst is to promote a second catalytic reaction of a product substance generated by the first catalytic reaction.

7. The reactor of claim 3, wherein the first member and the second member are disposed so that the first projections project in a different direction of height from the second projections.

8. The reactor of claim 6, wherein the first member and the second member are disposed so that the first projections project in a different direction of height from the second projections.

9. A fuel cell system comprising:
a reactor having;
a first member including plural first projections, the first projections including gaps between the respective first projections;
a second member including plural second projections, the second projections being so dimensioned as to at least partly enter into the gaps;
a catalyst supported on at least a part of surfaces of the first projections and the second projections; and
a case to house the first member and the second member, the case including an inflow port and an outflow port; and
a fuel cell to use a gas extracted from the reactor through the outflow port to generate electricity.

10. A fuel cell system comprising:
a reactor having;
a first member including plural first projections, the first projections including gaps between the respective first projections;
a second member including plural second projections, the second projections being so dimensioned as to at least partly enter into the gaps;
a first catalyst supported on at least a part of surfaces of the first projections;
a second catalyst supported on at least a part of surfaces of the second projections; and
a case to house the first member and the second member, the case including an inflow port and an outflow port; and
a fuel cell to use a gas extracted from the reactor through the outflow port to generate electricity.

11. A fuel cell system comprising:
a reactor having;
a first member including plural first projections;
a second member including plural second projections, the second member and the first member being arranged so that gaps between the first projections are respectively linked with the gaps between the second projections;
a first catalyst supported on at least a part of surfaces of the first projections;
a second catalyst supported on at least a part of surfaces of the second projections; and
a case to house the first member and the second member, the case including an inflow port and an outflow port; and
a fuel cell to use a gas extracted from the reactor through the outflow port to generate electricity.
